(19) United States
(12) Patent Application Publication
(10) Pub. No.: US 2025/0005443 A1
(43) Pub. Date: Jan. 2, 2025

(54) SYSTEM AND METHOD FOR AUTOMATED AND ACCURATE CORE PHOTOS LABELING IN MACHINE LEARNING BASED CORE PROPERTIES PREDICTION

(71) Applicant: SAUDI ARABIAN OIL COMPANY, Dhahran (SA)

(72) Inventors: Mokhles M. Mezghani, Dhahran (SA); Tao Lin, Katy, TX (US); Chicheng Xu, Houston, TX (US); Weichang Li, Katy, TX (US)

(73) Assignees: SAUDI ARABIAN OIL COMPANY, Dhahran (SA); ARAMCO SERVICES COMPANY, Houston, TX (US)

(21) Appl. No.: 18/345,113

(22) Filed: Jun. 30, 2023

(51) Int. Cl. G06N 20/00

(52) U.S. Cl. CPC G06N 20/00

(57) ABSTRACT

A method for analyzing rock cores of a subterranean formation is disclosed. The method includes capturing core images of the rock cores that are collected from geographical locations in the subterranean formation, generating, by a computer processor and from the core images, sub-images by sub-dividing each of the core images, classifying, using a secondary machine learning model that automatically identifies artifacts induced from preparation of the rock cores, the sub-images into artifact-free sub-images and artifact-containing sub-images, and analyzing, using a primary machine learning model, the artifact-free sub-images to generate a core analysis result.

### BACKGROUND

While drilling exploration or development wells, cores are extracted from the subsurface. These cores are an important source of information for subsurface characterization. After cores are extracted, they are placed in cylinders (usually 3 ft length cylinder) and then sent to the Exploration Core Laboratory for further analysis and visual examination. Thus, a core sample is a roughly cylindrical piece of subsurface material removed from exploration and appraisal wells by a special drill and brought to the surface for examination.

A core description is a summary of the information about a core sample based on visual examination and further core analysis. The visual examination relates to textural and sedimentary features and core colors. The core analysis relates to geological properties of subsurface material, such as rock.

### SUMMARY

In general, in one aspect, the invention relates to a method for analyzing rock cores of a subterranean formation. The method includes capturing a first plurality of core images of the rock cores that are collected from a plurality of geographical locations in the subterranean formation, generating, by a computer processor and from the first plurality of core images, a first plurality of sub-images by sub-dividing each of the first plurality of core images, classifying, using a secondary machine learning model that automatically identifies artifacts induced from preparation of the rock cores, the first plurality of sub-images into a plurality of artifact-free sub-images and a plurality of artifact-containing sub-images, and analyzing, using a primary machine learning model, the plurality of artifact-free sub-images to generate a core analysis result.

In general, in one aspect, the invention relates to a core image analyzer for analyzing rock cores of a subterranean formation. The core image analyzer includes a processor and a memory coupled to the processor and storing instruction, the instructions, when executed by the processor, comprising functionality for capturing a first plurality of core images of the rock cores that are collected from a plurality of geographical locations in the subterranean formation, generating, by a computer processor and from the first plurality of core images, a first plurality of sub-images by sub-dividing each of the first plurality of core images, classifying, using a secondary machine learning model that automatically identifies artifacts induced from preparation of the rock cores, the first plurality of sub-images into a plurality of artifact-free sub-images and a plurality of artifact-containing sub-images, and analyzing, using a primary machine learning model, the plurality of artifact-free sub-images to generate a core analysis result.

In general, in one aspect, the invention relates to a system. The system includes a wellbore penetrating a subterranean formation, a well control system of the wellbore, and a core image analyzer comprising functionality for capturing a first plurality of core images of rock cores that are collected from a plurality of geographical locations in the subterranean formation, generating, by a computer processor and from the first plurality of core images, a first plurality of sub-images by sub-dividing each of the first plurality of core images, classifying, using a secondary machine learning model that automatically identifies artifacts induced from preparation of the rock cores, the first plurality of sub-images into a plurality of artifact-free sub-images and a plurality of artifact-containing sub-images, and analyzing, using a primary machine learning model, the plurality of artifact-free sub-images to generate a core analysis result.

Other aspects and advantages will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A and 1B show a system in accordance with one or more embodiments.

FIG. 2 shows a flowchart in accordance with one or more embodiments.

FIGS. 3A-3E shows an example in accordance with one or more embodiments.

FIG. 4 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments of this disclosure provide a system and a method for analyzing rock cores of a subterranean formation. In one or more embodiments, core images of the rock cores collected from various geographical locations in a subterranean formation are captured, a set of sub-images is generated by sub-dividing each of the core images, the set of sub-images is classified into artifact-free sub-images and artifact-containing sub-images using a secondary machine learning model that automatically identifies artifacts induced from preparation of the rock cores, and the artifact-free sub-images are analyzed using a primary machine learning model to generate a core analysis result. Accordingly, a field operation of the subterranean formation is performed based at least on the core analysis result.

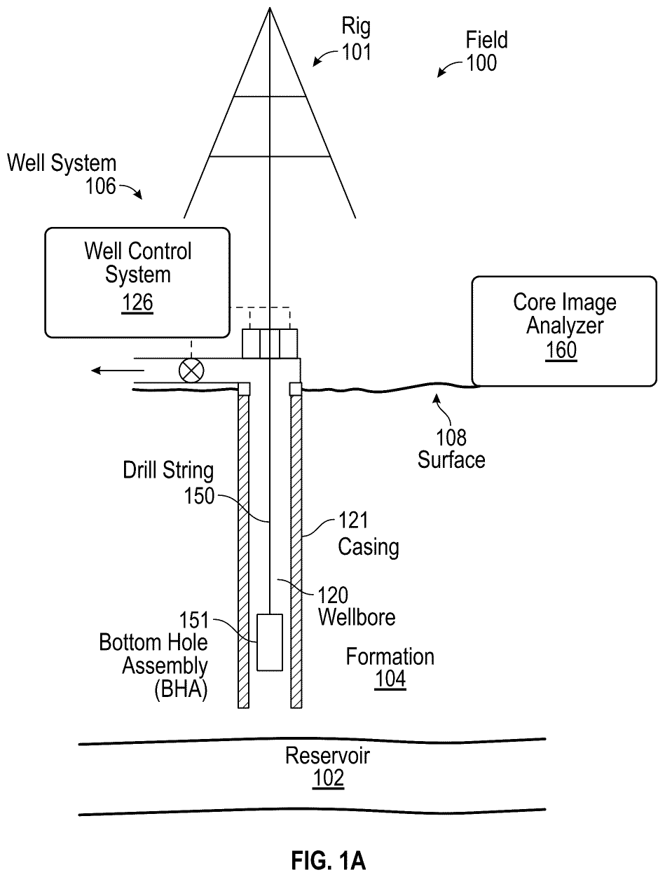

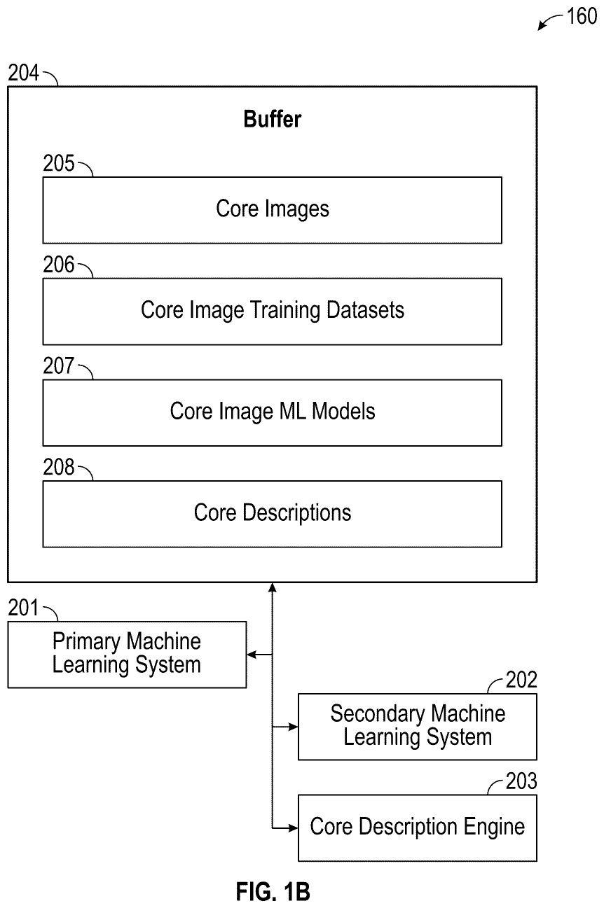

FIG. 1A shows a schematic diagram in accordance with one or more embodiments. As shown in FIG. 1A, a field (100) includes a subterranean formation (“formation”) (104) and a well system (106). The formation (104) may include a porous or fractured rock formation that resides underground, beneath the earth's surface (“surface”) (108). The formation (104) may include different layers of rock having varying characteristics, such as varying degrees of permeability, porosity, capillary pressure, and resistivity. In the case of the well system (106) being a hydrocarbon well, the formation (104) may include a hydrocarbon-bearing reservoir (102). In the case of the well system (106) being operated as a production well, the well system (106) may facilitate the extraction of hydrocarbons (or “production”) from the reservoir (102).

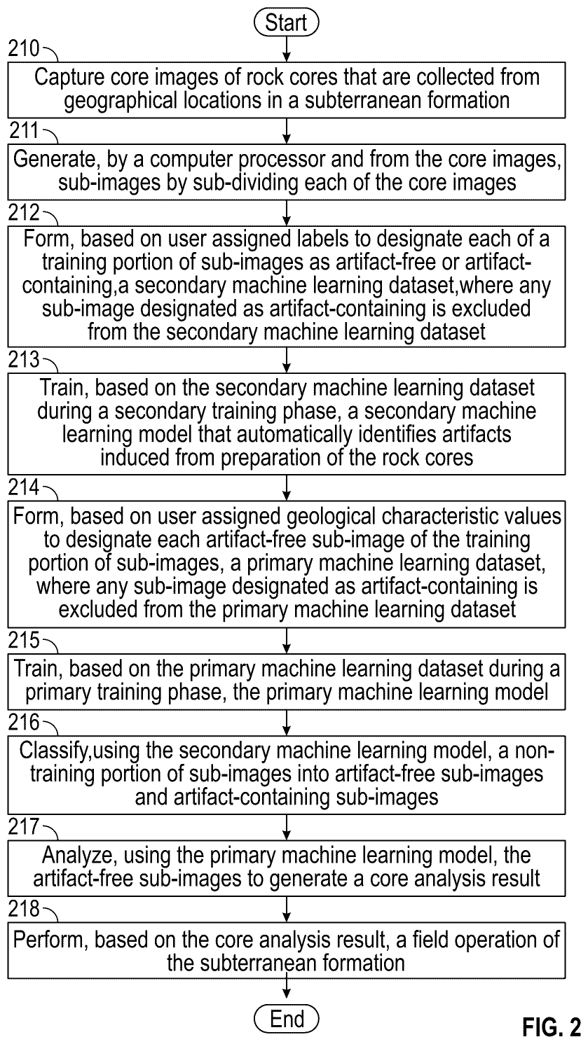

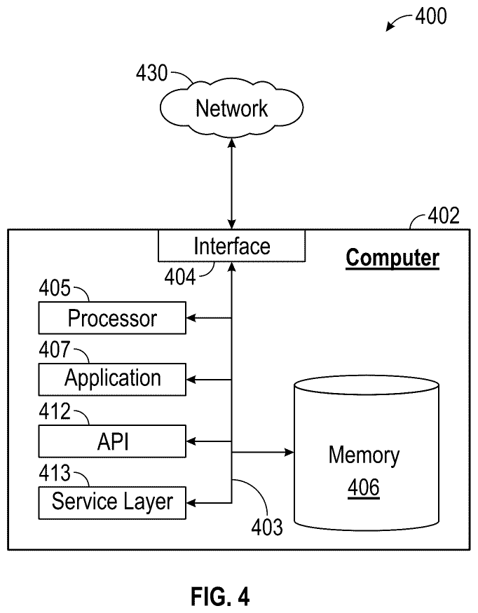

In some embodiments disclosed herein, the well system (106) includes a rig (101), a wellbore (120) with a casing (121), and a well control system (126). The well control system (126) may control various operations of the well system (106), such as well production operations, well drilling operation, well completion operations, well maintenance operations, and reservoir monitoring, assessment and development operations. In one or more embodiments, the well control system (126) performs these functionalities using the method described in reference to FIG. 2 below. In some embodiments, the well control system (126) includes a computer system, such as a portion of the computing system described in reference to FIG. 4 below.

The rig (101) is the machine used to drill a borehole to form the wellbore (120). Major components of the rig (101) include the drilling fluid tanks, the drilling fluid pumps (e.g., rig mixing pumps), the derrick or mast, the draw works, the rotary table or top drive, the drill string, the power generation equipment and auxiliary equipment. Drilling fluid, also referred to as “drilling mud” or simply “mud,” is used to facilitate drilling boreholes into the earth, such as drilling oil and natural gas wells. The main functions of drilling fluids include providing hydrostatic pressure to prevent formation fluids from entering into the borehole, keeping the drill bit cool and clean during drilling, carrying out drill cuttings, and suspending the drill cuttings while drilling is paused and when the drilling assembly is brought in and out of the borehole.

The wellbore (120) includes a bored hole (i.e., borehole) that extends from the surface (108) towards a target zone of the formation (104), such as the reservoir (102). An upper end of the wellbore (120), terminating at or near the surface (108), may be referred to as the “up-hole” end of the wellbore (120), and a lower end of the wellbore, terminating in the formation (104), may be referred to as the “downhole” end of the wellbore (120). The wellbore (120) may facilitate the circulation of drilling fluids during drilling operations for the wellbore (120) to extend towards the target zone of the formation (104) (e.g., the reservoir (102)), facilitate the flow of hydrocarbon production (e.g., oil and gas) from the reservoir (102) to the surface (108) during production operations, facilitate the injection of substances (e.g., water) into the hydrocarbon-bearing formation (104) or the reservoir (102) during injection operations, or facilitate the communication of monitoring devices (e.g., logging tools) lowered into the formation (104) or the reservoir (102) during monitoring operations (e.g., during in situ logging operations).

In some embodiments, the well system (106) is provided with a bottom hole assembly (BHA) (151) attached to the drill string (150) to suspend into the wellbore (120) for performing the well drilling operation. The bottom hole assembly (BHA) is the lowest part of a drill string and includes the drill bit, drill collar, stabilizer, mud motor, etc.

A rock core is a cylindrical section of a natural substance, such as sediment or rock. Rock cores are usually obtained by drilling with a coring bit (e.g., hollow steel tube) into the sediment or rocks. In some embodiments, rock cores at different depths are extracted through the wellbore (120) from various formation layers. In addition, multiple sets of rock cores may be extracted through multiple boreholes throughout the field (100) and correspond to a wide range of formation zones. Each rock core column is a sequence of rock cores extracted from a particular borehole and extending across a depth range of interest in the borehole. In particular, each rock core is marked to indicate the depths where it is extracted in the borehole. A core-plug is a rock sample taken (e.g., cut or drilled) from a rock core for analysis. Core plugs are typically 1″ to 1.5″ (i.e., approximately 2.5 to 3.8 cm) in diameter and 1″ to 2″ (i.e., approximately 2.5 to 5 cm) in length. Each core-plug corresponds to a particular formation zone according to the depth markings of the rock core in the rock column. Throughout this disclosure, the term “sample” refers to a rock sample or core-plug taken from a rock core and the term “sample depth” refers to the depth where the rock core is extracted from the borehole.

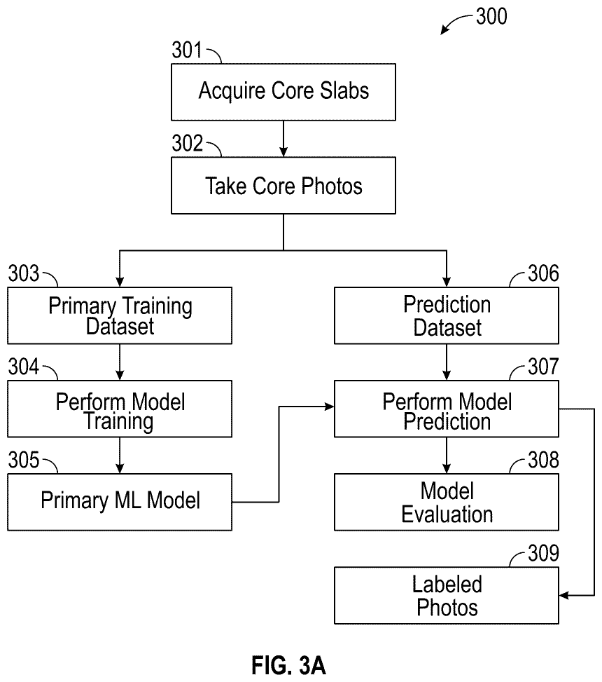

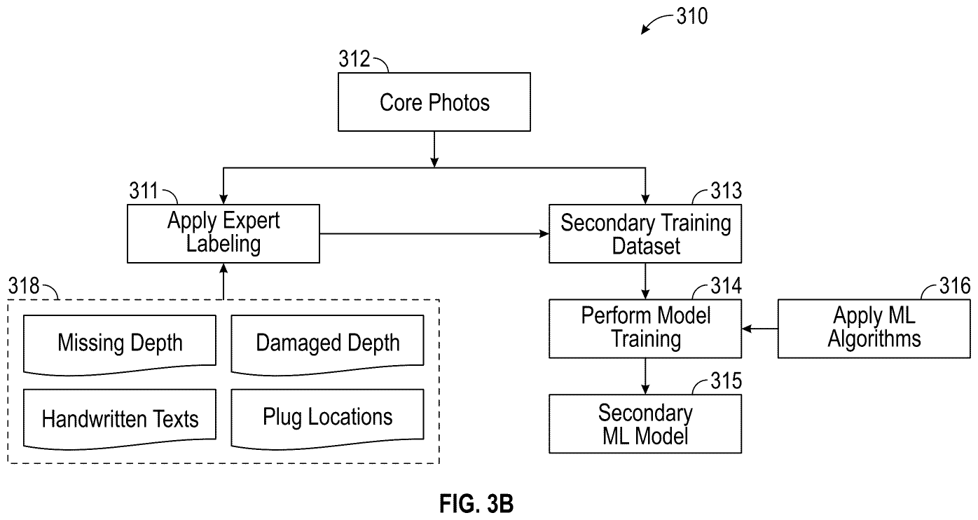

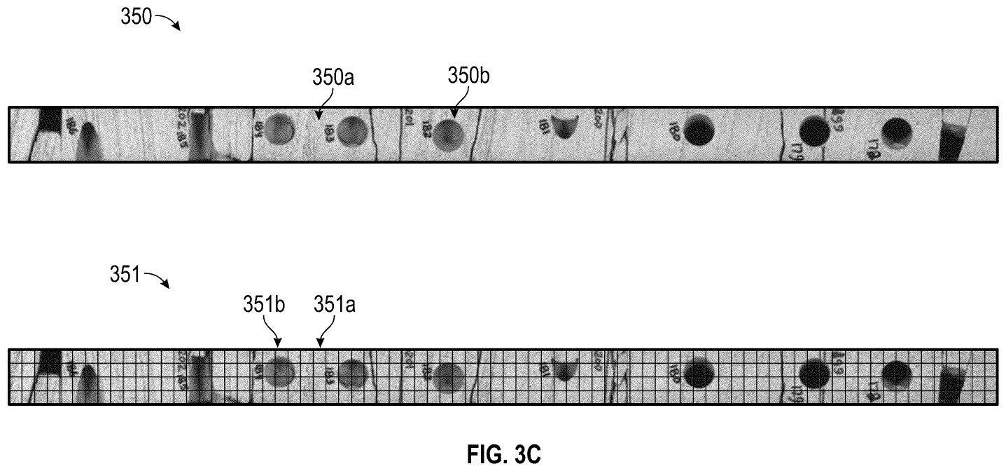

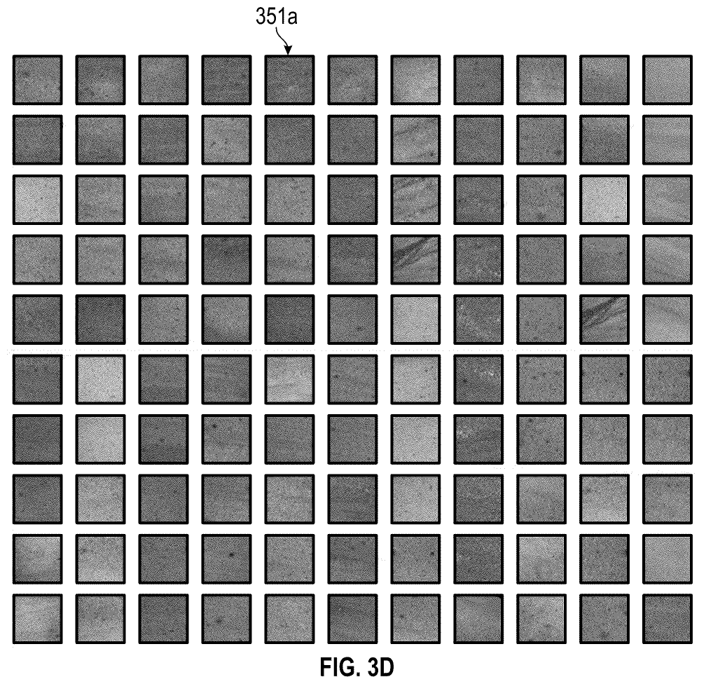

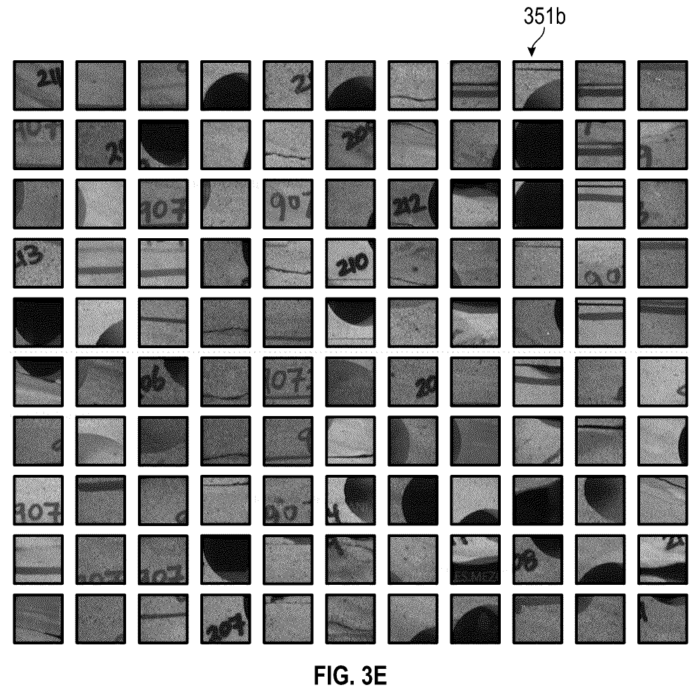

In some embodiments, the core image analyzer (160) may include hardware and/or software with functionality for classifying and analyzing core samples from various formation zones. For example, the core image analyzer (160) may store logs and data regarding core samples for performing classification and analysis. While the core image analyzer (160) is shown at a well site, in alternative embodiments the core image analyzer (160) may also be located away from well sites. In some embodiments, the core image analyzer (160) may include components similar to that described below with regard to FIGS. 1B and 3A-3E and the accompanying description. Further, the core image analyzer (160) may include a computer system that is similar to the computer system (400) described below with regard to FIG. 4 and the accompanying description.

Turning to FIG. 1B, FIG. 1B shows a schematic diagram in accordance with one or more embodiments. In one or more embodiments, one or more of the modules and/or elements shown in FIG. 1B may be omitted, repeated, and/or substituted. Accordingly, embodiments of the invention should not be considered limited to the specific arrangements of modules and/or elements shown in FIG. 1B.

As shown in FIG. 1B, the core image analyzer (160) has multiple components, including, for example, a buffer (204), a primary machine learning system (201), a secondary machine learning system (202), and a core description engine (203). Each of these components (201, 202, 203, 204) may be located on the same computing device (e.g., personal computer (PC), laptop, tablet PC, smart phone, multifunction printer, kiosk, server, etc.) or on different computing devices that are connected via a network, such as a wide area network or a portion of Internet of any size having wired and/or wireless segments. Each of these components is discussed below.

In one or more embodiments of the invention, the buffer (204) may be implemented in hardware (i.e., circuitry), software, or any combination thereof. The buffer (204) is configured to store data generated and/or used by the core image analyzer (160). The data stored in the buffer (204) includes the core images (205), the core image training datasets (206), the core image machine learning (ML) models (207), and the core descriptions (208).

The core images (205) are photographs of rock cores, i.e., core photos. The core images (205) include photographs of a number of rock core columns collected from different geographical locations throughout an area of interest. Each rock core column is a sequence of rock cores extending across a depth range of interest in the borehole. In particular, each rock core is marked to indicate the locations and depths such that the markings are captured in the corresponding core image. Core plugs are taken from the rock core leaving holes in the rock core that show up in the corresponding core images. In one or more embodiments, the core images (205) are captured using a high speed configuration of automated core imaging equipment, such as an onsite camera at the well site. The core images (205) are sub-divided into sub-images that are classified as including or excluding induced artifacts such as the depth marking and core plug holes from preparing the core samples. These classified sub-images are used for machine learning based core properties prediction.

Machine learning (ML), broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning (ML), or machine-learned, will be adopted herein, however, one skilled in the art will recognize that the concepts and methods detailed hereafter are not limited by this choice of nomenclature.

Machine-learned model types may include, but are not limited to, k-means, k-nearest neighbors, neural networks, logistic regression, random forests, generalized linear models, and Bayesian regression. Also, machine-learning encompasses model types that may further be categorized as “supervised”, “unsupervised”, “semi-supervised”, or “reinforcement” models. One with ordinary skill in the art will appreciate that additional or alternate machine-learned model categorizations may be defined without departing form the scope of this disclosure. Machine-learned model types are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a model is referred to as selecting the model “architecture.”

A cursory introduction to a few machine-learned models and the general principles related to training a supervised machine-learned model are provided below. However, while descriptions of machine-learned models are provided to aid in understanding, one with ordinary skill in the art will recognize that these descriptions do not impose a limitation on the instant disclosure. This is because one with ordinary skill in the art will appreciate that, due to the depth and breadth of the field, a detailed description of the field of machine learning, and the various model types encompassed by the field, cannot be adequately summarized in the present disclosure.

In machine learning, algorithms are trained to find patterns and correlations in large training data sets and to make the best decisions and predictions based on that analysis. Machine learning algorithms build a model based on sample data, known as training data, in order to make predictions or decisions without being explicitly programmed to do so. A training data set is a dataset of examples used during the learning process to fit the parameters of machine learning algorithms, such as weights of a classifier.

Artificial neural networks (ANNs) are a subset of machine learning in deep learning algorithms. The ANN includes node layers, i.e., an input layer, one or more hidden layers, and an output layer. Each node connects to another node and has an associated weight and threshold. If the output of any individual node is above the specified threshold value, that node is activated, sending data to the next layer of the network. Otherwise, no data is passed along to the next layer of the network. ANNs rely on training data to learn and improve their accuracy over time. A convolutional neural network (CNN) is a class of ANN most commonly applied to analyze visual imagery. CNNs use a mathematical operation called convolution in place of general matrix multiplication in at least one of their layers. CNNs are specifically designed to process pixel data and are used in image recognition and processing.

Based on the foregoing, the core image training datasets (206) are machine learning training datasets for training machine learning (ML) models. Specifically, the core image training datasets (206) includes a primary machine learning training dataset for training a primary ML model and a secondary machine learning training dataset for training a secondary ML model.

The core image machine learning (ML) models (207) are machine learning models and include the primary ML model and the secondary ML model. In one or more embodiments, the ML models (207) include CNNs. Specifically, the primary ML model is trained to automatically predict geological properties of rock cores based on sub-images of core photos. The secondary ML model is trained to identify induced artifacts in core photos and classify the sub-images as including or excluding the induced artifacts.

In one or more embodiments of the invention, each of the primary ML system (201), the secondary ML system (202), and the core description engine (203) may be implemented in hardware (i.e., circuitry), software, or any combination thereof. The primary ML system (201) is configured to generate predictions of geological properties of rock samples using the primary ML model. The secondary ML system (202) is configured to classify using the secondary ML model sub-images of the core photos in the primary machine learning training dataset to eliminate or otherwise disregard induced artifacts so as to improve the accuracy of the primary machine learning system (201). The core description engine (203) is configured to analyze and compile the predicted geological properties from the primary machine learning system (201) into corresponding core descriptions.

In one or more embodiments, the core image analyzer (160) performs the functionalities described above by a process described in reference to FIG. 2 below. Although the core image analyzer (160) is shown as having four engines (201, 202, 203, 204), in other embodiments of the invention, the core image analyzer (160) may have more or fewer engines and/or more or fewer other components. Further, the functionality of each component described above may be split across components. Furthermore, each component (201, 202, 203, 204) may be utilized multiple times to carry out an iterative operation.

FIG. 2 shows a flowchart in accordance with one or more embodiments. Specifically, FIG. 2 describes a method of generating core descriptions based on a machine learning based approach with automated and accurate core photo labeling and classification. A field operation is then performed according to the generated core descriptions. One or more blocks in FIG. 2 may be performed using one or more components as described in FIGS. 1A-1B. While the various blocks in FIG. 2 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Turning to FIG. 2, initially in Block 210, core images of rock cores collected from geographical locations in a subterranean formation are captured. Coring is performed to extract rock cores from a number of geographical locations in an area of interest of the subterranean formation. The extracted rock cores are slabbed with core plugs removed for analysis. The slabbed and plugged rock cores are then marked and organized according to respective depths and locations where the rock cores are collected. After preparing the rock cores, core images are captured, e.g., using a high speed configuration of automated core imaging equipment such as an onsite camera the wellsite. Image pre-processing may be performed to normalize the images, such as illumination/brightness compensation, color temperature calibration, lens distortion correction, etc. Markings and plugged holes on the rock cores and other artifacts are captured in each core image. In one or more embodiments, a portion of the core images may be captured for machine learning training prior to or during one or more training phase(s) and is referred to as a training portion or a training data set of the core images. The remaining portion of the core images that are not used for machine learning training may be captured subsequent to the training phase(s) and is referred to as a non-training portion of the core images.

In Block 211, sub-images are generated from the core images by sub-dividing each of the core images. In one or more embodiments, a training portion of the sub-images are generated prior to or during the training phase(s) of machine learning training. A non-training portion of the sub-images are generated subsequent to the training phase(s) of machine learning training.

In Block 212, a secondary machine learning dataset is formed based on user assigned labels to designate each of the training portion of the sub-images as artifact-free or artifact-containing. Any sub-image designated as artifact-containing is excluded from the secondary machine learning dataset. For example, the artifacts may include one or more of a hand written text, a core plug location, a core breakage, and a missing portion of the rock cores.

In Block 213, a secondary machine learning model is trained based on the secondary machine learning dataset during a secondary training phase. The secondary machine learning model is trained to automatically identify artifacts induced from preparation of the rock cores. In one or more embodiments, the secondary machine learning system is applied to select the core photos that are used for the primary machine learning system training.

In Block 214, a primary machine learning dataset is formed based on user assigned geological characteristic values to designate each artifact-free sub-image of the training portion of the sub-images. Any sub-image designated as artifact-containing is excluded from the primary machine learning dataset.

In Block 215, a primary machine learning model is trained based on the primary machine learning dataset during a primary training phase. The primary ML model is trained to automatically predict geological properties of rock cores.

In Block 216, the non-training portion of the sub-images is classified using the secondary machine learning model into artifact-free sub-images and artifact-containing sub-images.

In Block 217, the artifact-free sub-images in the non-training portion of the sub-images are analyzed using the primary machine learning model to generate a core analysis result. For example, the core analysis result may indicate the porosity, permeability, fluid saturation, grain density, and other geological characteristics of a corresponding geographical location in the subterranean formation.

In Block 218, a field operation of the subterranean formation is performed based on the core analysis result. For example, the field operation may include continuing drilling and/or completing the wellbore, planning and/or initiating production of the wellbore, etc. In another example, exploration and/or development of the wellbore may be discontinued based on the core analysis result. Further, a target location may be selected, based on the core analysis result, from multiple geographical locations in the area of interest of the subterranean formation. For example, the target location may be selected based on porosity, permeability, fluid saturation, grain density, or other geological characteristics indicated by the core analysis result regarding the target location. Accordingly, the field operation is then performed at the selected target location.

FIGS. 3A-3E show an example in accordance with one or more embodiments. The example shown in FIGS. 3A-3E is based on the system and method described in reference to FIGS. 1A-1B and 2 above. Specifically, FIGS. 3A-3E illustrate systems and methods to automatically obtain accurate labeled core images that can be used for geological core properties prediction from core images using machine learning. In particular, the core images are labeled by classifying sub-images as artifact-free or artifact-containing. In one or more embodiments, one or more of the modules and/or elements shown in FIGS. 3A-3E may be omitted, repeated, combined and/or substituted. Accordingly, embodiments disclosed herein should not be considered limited to the specific arrangements of modules and/or elements shown in FIGS. 3A-3E.

Oil and gas companies usually dispose of a large volume of geological cores that can be used to train machine learning models for generating core descriptions or performing other automated core analysis. FIG. 3A illustrates a primary machine learning system (300) where a primary machine learning (ML) model (305) is trained to predict geological core properties (e.g., porosity, permeability, rock density, elastic properties, etc.) from core photos. Initially in Block 301, core slabs are acquired. While drilling exploration or development wells, cores are extracted from the subsurface. These cores are an important source of information for subsurface characterization. After cores are extracted, they are placed in cylinders (usually 3 ft length cylinder) and then sent to the exploration core laboratory for further analysis and visual examination.

Some of these analyses require the extraction of several samples (e.g., core plugs) from each core (e.g., 3 ft in length). The spacing of the plugs can vary from 0.5 ft to 1.0 ft apart on the core where they are extracted. For visual examination, the core is slabbed in two parts (¼ and ¾ for 4 inches core diameter) after extracting plugs. On the slabbed core, a handwritten text is added to the slabbed face of the core to mark the extracted plug identifier and the core depth (e.g., every foot).

In Block 302, core photos are taken from the cores. For example, a high-resolution photo of the slabbed core is taken, such as the example photo (350) shown in FIG. 3C where the handwritten text (350a) and extracted plug location (350b) are depicted. These core photos are used to form the primary training dataset (303) and the prediction dataset (306) for training and evaluating the primary ML model (305).

The primary training dataset (303) includes core photos that are labeled by descriptions of the geological core properties as determined by subjecting the core plugs to laboratory analysis. The prediction dataset (306) includes core photos where the geological core properties are to be predicted using the primary ML model (305) and evaluated by the human expert for validation. The utilization of these core photos in the primary training dataset (303) and the prediction dataset (306) for the primary machine learning system (300) to predict the core properties will not be accurate if induced artifacts are not automatically and accurately identified. Specifically, the induced artifacts identified in the core photos are disregarded during the training of the machine learning model. In one or more embodiments, the induced artifacts include (i) missing depth intervals such as core segments without core photos or physical core sample, (ii) damaged depth intervals such as core segments with breakage or fragmented core preserved in plastic bag, (iii) handwritten texts such as painted text on the core sample showing depth or plug identification number, and (iv) plug locations that show up as black circular shape in the core photos.

The primary training dataset (303) and the prediction dataset (306) are conventionally prepared by the human expert's visual inspection of the core photos to identify these induced artifacts. This approach is feasible when dealing with a small number of core photos but becomes impractical for a large training dataset with a large number of core photos. A secondary machine learning system is described in reference to FIG. 3B below to identify these induced artifacts and select the core photos that will be used for the primary machine learning system training. In particular, this secondary system will automatically predict the induced undesired artifacts from the core photos.

In Block 304, machine learning procedures are performed based on the primary training dataset (303) to generate/train the primary ML model (305). In one or more embodiments, the primary ML model (305) includes a Convolutional Neural Network (CNN).

In Block 307, model prediction is performed by applying prediction algorithms to the prediction dataset (306) to generate labeled photos (309) where the core photos in the prediction dataset (306) are labeled with predicted geological properties. The labeled photos (309) are then compared to actual geological properties determined from laboratory analysis results to generate the model evaluation (308). The model evaluation (308) represents the extent of how predicted geological properties matches the actual geological properties. The primary ML model (305) is then validated if the model evaluation (308) indicates sufficient match between the predicted geological properties and the actual geological properties. Once validated, the primary ML model (305) is used to generate predicted geological properties for core photos that are not included in the primary training dataset (303) and the prediction dataset (306). In other words, the primary ML model (305) is used to automatically generate the core descriptions based on the core photos of extracted core samples.

FIG. 3B illustrates a secondary machine learning system (310) where a secondary machine learning model (315) is trained to automatically identify the aforementioned induced artifacts in the core photos (312) and qualify/classify the core photos (312) for the primary machine learning system training. Initially in Block 311, expert labeling (318) regarding the induced artifacts are applied to core photos (312) to form the secondary training dataset (313). The core photos (312) are subdivided to sub-images using a moving window with or without overlap. An example of a subdividing the core photo (350) without overlap into a subdivided core photo (351) is shown in FIG. 3C. For example, the subdivided core photo (351) includes sub-images (351a, 351b). Sub-images are then classified to train the secondary machine learning system for automatically induced artifact detection.

As noted above, the induced artifacts include four different types listed in the expert labeling (318). Because the primary ML model is to be trained for prediction of the geological core properties regardless of specific types of induced artifacts, only the presence or not of induced artifacts is included in the labeled sub-images when applying the expert labeling (318). Specifically, each sub-image in the secondary training dataset (313) is labeled as class I: images showing only rock part or class II: images showing at least part of the undesired induced artifact.

In Block 314, machine learning procedures are performed based on the secondary training dataset (313) to generate/train the secondary ML model (315). Specifically, in Block 316, machine learning algorithms are applied to perform the machine learning procedures. In one or more embodiments, the secondary ML model (315) includes a Convolutional Neural Network (CNN). Once trained and validated, the secondary ML model (315) is used to classify sub-images in the primary training dataset (303) where those sub-images labeled as class II are disregarded in Block 304 to perform model training and generating the primary ML model (305). FIG. 3D shows example class I sub-images (e.g., sub-image (351a)) in the primary training dataset (303) that are used in generating the primary ML model (305). FIG. 3E shows example class II sub-images (e.g., sub-image (351b)) in the primary training dataset (303) that are eliminated or otherwise disregarded in generating the primary ML model (305).

One or more embodiments disclosed herein present an imbedded dual machine learning system to automatically optimize the quality of the training dataset. Such an AI-based automated quality-control of the labeled dataset allows for automatically identifying the undesired artefact in the photos to discard them from the training dataset.

Embodiments may be implemented on a computer system. FIG. 4 is a block diagram of a computer system (402) used to provide computational functionalities associated with described algorithms, methods, functions, processes, flows, and procedures as described in the instant disclosure, according to an implementation. The illustrated computer (402) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

In some embodiments, the computer (402) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AlaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for analyzing rock cores of a subterranean formation, the method comprising:
capturing a first plurality of core images of the rock cores that are collected from a plurality of geographical locations in the subterranean formation;
generating, by a computer processor and from the first plurality of core images, a first plurality of sub-images by sub-dividing each of the first plurality of core images;
classifying, using a secondary machine learning model that automatically identifies artifacts induced from preparation of the rock cores, the first plurality of sub-images into a plurality of artifact-free sub-images and a plurality of artifact-containing sub-images; and
analyzing, using a primary machine learning model, the plurality of artifact-free sub-images to generate a core analysis result.

2. The method according to claim 1, further comprising:
capturing a second plurality of core images of the rock cores;
generating, from the second plurality of core images, a second plurality of sub-images by sub-dividing each of the second plurality of core images;
forming, based on user assigned labels to designate each of the second plurality of sub-images as artifact-free or artifact-containing, a secondary machine learning dataset, wherein any sub-image designated as artifact-containing is excluded from the secondary machine learning dataset; and
training, based on the secondary machine learning dataset during a secondary training phase prior to classifying the first plurality of sub-images, the secondary machine learning model.

3. The method according to claim 1,
wherein the artifacts comprise one or more of a hand written text, a core plug location, a core breakage, and a missing portion of the rock cores.

4. The method according to claim 2, further comprising:
forming, based on user assigned geological characteristic values to designate each artifact-free sub-image of the second plurality of sub-images, a primary machine learning dataset, wherein any sub-image designated as artifact-containing is excluded from the primary machine learning dataset; and
training, based on the primary machine learning dataset during a primary training phase prior to analyzing the plurality of artifact-free sub-images to generate the core analysis result, the primary machine learning model.

5. The method according to claim 1, further comprising:
performing, based on the core analysis result, a field operation of the subterranean formation.

6. The method according to claim 5, further comprising:
selecting, from the plurality of geographical locations and based on the core analysis result, a target location,
wherein the core analysis result comprises geological characteristics of the plurality of geographical locations, and
wherein the field operation is performed at the target location.

7. The method according to claim 6,
wherein the geological characteristics comprise one or more of porosity, permeability, fluid saturation, and grain density of the rock cores.

8. A core image analyzer for analyzing rock cores of a subterranean formation, comprising:
a processor; and
a memory coupled to the processor and storing instruction, the instructions, when executed by the processor, comprising functionality for:
capturing a first plurality of core images of the rock cores that are collected from a plurality of geographical locations in the subterranean formation;
generating, by a computer processor and from the first plurality of core images, a first plurality of sub-images by sub-dividing each of the first plurality of core images;
classifying, using a secondary machine learning model that automatically identifies artifacts induced from preparation of the rock cores, the first plurality of sub-images into a plurality of artifact-free sub-images and a plurality of artifact-containing sub-images; and
analyzing, using a primary machine learning model, the plurality of artifact-free sub-images to generate a core analysis result.

9. The core image analyzer according to claim 8, the instructions, when executed by the processor, further comprising functionality for:
capturing a second plurality of core images of the rock cores;
generating, from the second plurality of core images, a second plurality of sub-images by sub-dividing each of the second plurality of core images;
forming, based on user assigned labels to designate each of the second plurality of sub-images as artifact-free or artifact-containing, a secondary machine learning dataset, wherein any sub-image designated as artifact-containing is excluded from the secondary machine learning dataset; and
training, based on the secondary machine learning dataset during a secondary training phase prior to classifying the first plurality of sub-images, the secondary machine learning model.

10. The core image analyzer according to claim 8,
wherein the artifacts comprise one or more of a hand written text, a core plug location, a core breakage, and a missing portion of the rock cores.

11. The core image analyzer according to claim 9, the instructions, when executed by the processor, further comprising functionality for:
forming, based on user assigned geological characteristic values to designate each artifact-free sub-image of the second plurality of sub-images, a primary machine learning dataset, wherein any sub-image designated as artifact-containing is excluded from the primary machine learning dataset; and
training, based on the primary machine learning dataset during a primary training phase prior to analyzing the plurality of artifact-free sub-images to generate the core analysis result, the primary machine learning model.

12. The core image analyzer according to claim 8, the instructions, when executed by the processor, further comprising functionality for:
performing, based on the core analysis result, a field operation of the subterranean formation.

13. The core image analyzer according to claim 12, the instructions, when executed by the processor, further comprising functionality for:
selecting, from the plurality of geographical locations and based on the core analysis result, a target location,
wherein the core analysis result comprises geological characteristics of the plurality of geographical locations, and
wherein the field operation is performed at the target location.

14. The core image analyzer according to claim 13,
wherein the geological characteristics comprise one or more of porosity, permeability, fluid saturation, and grain density of the rock cores.

15. A system, comprising:
a wellbore penetrating a subterranean formation;
a well control system of the wellbore; and
a core image analyzer comprising functionality for:
capturing a first plurality of core images of rock cores that are collected from a plurality of geographical locations in the subterranean formation;
generating, by a computer processor and from the first plurality of core images, a first plurality of sub-images by sub-dividing each of the first plurality of core images;
classifying, using a secondary machine learning model that automatically identifies artifacts induced from preparation of the rock cores, the first plurality of sub-images into a plurality of artifact-free sub-images and a plurality of artifact-containing sub-images; and
analyzing, using a primary machine learning model, the plurality of artifact-free sub-images to generate a core analysis result.

16. The system according to claim 15, the core image analyzer further comprising functionality for:
capturing a second plurality of core images of the rock cores;
generating, from the second plurality of core images, a second plurality of sub-images by sub-dividing each of the second plurality of core images;
forming, based on user assigned labels to designate each of the second plurality of sub-images as artifact-free or artifact-containing, a secondary machine learning dataset, wherein any sub-image designated as artifact-containing is excluded from the secondary machine learning dataset; and
training, based on the secondary machine learning dataset during a secondary training phase prior to classifying the first plurality of sub-images, the secondary machine learning model.

17. The system according to claim 15,
wherein the artifacts comprise one or more of a hand written text, a core plug location, a core breakage, and a missing portion of the rock cores.

18. The system according to claim 16, the core image analyzer further comprising functionality for:
forming, based on user assigned geological characteristic values to designate each artifact-free sub-image of the second plurality of sub-images, a primary machine learning dataset, wherein any sub-image designated as artifact-containing is excluded from the primary machine learning dataset; and
training, based on the primary machine learning dataset during a primary training phase prior to analyzing the plurality of artifact-free sub-images to generate the core analysis result, the primary machine learning model.

19. The system according to claim 15, the core image analyzer further comprising functionality for:
performing, based on the core analysis result, a field operation of the subterranean formation.

20. The system according to claim 19, the core image analyzer further comprising functionality for:
selecting, from the plurality of geographical locations and based on the core analysis result, a target location,
wherein the core analysis result comprises geological characteristics of the plurality of geographical locations, and
wherein the field operation is performed at the target location.
